(19) United States
(12) Patent Application Publication
(10) Pub. No.: US 2012/0151265 A1
(43) Pub. Date: Jun. 14, 2012

(54) SUPPORTING CLUSTER LEVEL SYSTEM DUMPS IN A CLUSTER ENVIRONMENT

(75) Inventors: Carl Duane Bender, Pflugerville, TX (US); Jacob Jason Rosales, Austin, TX (US); Morgan Jeffrey Rosas, Cedar Park, TX (US); Vasu Vallabhaneni, Austin, TX (US)

(73) Assignee: IBM Corporation, Armonk, NY (US)

(21) Appl. No.: 12/964,079

(22) Filed: Dec. 9, 2010

(51) Int. Cl. G06F 11/07

(52) U.S. Cl. 714/37; 714/E11.029

(57) ABSTRACT

A method, system, and computer program product provides simultaneous debugging of multiple OS image and/or system dump pairs in a distributed storage repository. A management console receives a terminal debugging session request and a cluster selection from an interface and starts a debugger instance. The debugger instance autonomously identifies client LPARs and loads the system dump images assigned to the client LPARs. In response to receiving a selection of a first and second client LPARs, the debugger analyzes the first and second system dump images, respectively, and calculates relational information between the first analysis and the second analysis via one or more logical reasoning utilities of the management console. The debugger then loads the relational information to the management console interface with an analysis of one or more similarities between the first and second system dumps.

### BACKGROUND

1. Technical Field

The present invention relates in general to data processing systems and in particular to management and utilization of shared storage within a clustered data processing system. Still more particularly, the present invention relates to an improved method and system for supporting multiple OS image and system dump pairs to enable cluster system level dumps in a distributed storage repository.

2. Description of the Related Art

Large scale, distributed data processing systems are known in the art. As cloud computing becomes more and more ubiquitous in the computer world, methods for providing enhanced functionality and greater up-time are required to continue to adequately serve commercial needs. In today's computing environment, developers and support personnel rely heavily on debug tools. As computing environments continue to evolve, and become dispersed across states or even countries, being able to access all the information takes time and is cumbersome.

With the increasing popularity of virtual and clustered environments, the problem is exacerbated. In this environment multiple nodes within the cluster may all require debug analysis. With the current technology, one would be required to load each system dump image one at a time on separate consoles or terminals in order to identify any relationships that could have cause a cluster wide crash. This method is inefficient, and prone to numerous errors.

### SUMMARY OF AN EMBODIMENT

Disclosed are a method, system, and computer program products for supporting simultaneous debugging of multiple OS image and/or system dump pairs in a distributed storage repository. A management console receives a terminal debugging session request and a cluster selection from an interface and starts a debugger instance. The debugger instance autonomously identifies client LPARs and loads the system dump images assigned to the client LPARs. In response to receiving a selection of a first and second client LPAR, the debugger analyzes the first and second system dump images, respectively, and calculates relational information between the first analysis and the second analysis via one or more logical reasoning utilities of the management console. The debugger then loads the relational information to the management console interface with an analysis of one or more similarities between the first and second system dumps.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The described embodiments are to be read in conjunction with the accompanying drawings, wherein:

FIG. 1A illustrates a first view of a cluster (aware) data processing system within which various of the functional features of the described embodiments are implemented, according to one embodiment;

FIG. 1B illustrates a second view of the cluster data processing system (DPS) of FIG. 1A depicting additional functional components within the computing complexes and shared storage, according to one embodiment;

FIG. 1C illustrates a third view of the cluster data processing system (DPS) of FIG. 1A depicting virtual IO connectivity from client logical partitions (LPARs) to assigned client logical units or disks, according to one or more embodiments;

FIG. 2 illustrates an internal configuration of a computing electronic complex (CEC) within the cluster DPS having virtualized OS partitions, including virtual I/O server (VIOS) partitions, according to one embodiment;

FIG. 3 is a flow chart of the method by which the process of client creation and registration is completed within a CA_DPS, according to one embodiment;

FIG. 4 is a block diagram representation of a cluster aware VIOS architecture that provides simultaneous debugging of multiple system dump pairs in a cluster environment, according to one embodiment;

FIG. 5 is a high level logical flowchart of an exemplary process for debugging system dump pairs in a cluster environment, according to one embodiment;

FIG. 6 is a high level logical flowchart of the process for determining similarities and/or differences between system dump relational information of system dump pairs in a cluster environment, according to one embodiment; and

FIG. 7 is a high level logical flowchart of a data processing system management console with hardware and software components that can be utilized to simultaneously debug multiple OS image and/or system dump images in a cluster environment from a single management console, according to one embodiment.

### DETAILED DESCRIPTION

The illustrative embodiments provide a method, data processing system, and computer program product that supports simultaneous debugging of multiple OS image and/or system dump pairs in a cluster environment from a single management console. The method is performed within a clustered, data processing system (DPS) environment/architecture in which one or more cluster-aware virtual input/output server (VIOS) enable efficient, secure access for a LPAR to a single shared, network storage resource of the cluster. The client LPAR and VIOS are located on a computing electronic complex (CEC), which is a computing node within the cluster environment.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment.

It is understood that the use of specific component, device and/or parameter names (such as those of the executing utility/logic/firmware described herein) are for example only and not meant to imply any limitations on the invention. The invention may thus be implemented with different nomenclature/terminology utilized to describe the components/devices/parameters herein, without limitation. References to any specific protocol or proprietary name in describing one or more elements, features or concepts of the embodiments are provided solely as examples of one implementation, and such references do not limit the extension of the invention to embodiments in which different element, feature or concept names are utilized. Thus, each term utilized herein is to be given its broadest interpretation given the context in which that terms is utilized. For example, as utilized herein, the term cluster-aware refers to the operational state of each VIOS within the cluster where the VIOSes contain information about which other VIOSes are connected within the cluster, the configuration of the different CECs within the DPS supported by the cluster, information about which client LPARs are supported by each VIOS, and other state and operating information and data related to performing VIO operations using the physical I/O devices of the DPS and those of the distributed storage repository (storage repository). Cluster awareness is supported by both a shared, networked VIOS database and locally maintained copies of VIOS cluster data within each VIOS.

As further described below, implementation of the functional features of the invention is provided within processing devices/structures and involves use of a combination of hardware, firmware, as well as several software-level constructs (e.g., program code). The presented figures illustrate both hardware components and software components within example data processing architecture having a specific number of processing nodes (e.g., computing electronic complexes). The illustrative and described embodiments assume that the system architecture may be scaled to a much larger number of processing nodes.
In the following descriptions, headings or section labels are provided to separate functional descriptions of portions of the invention provided in specific sections. These headings are provided to enable better flow in the presentation of the illustrative embodiments, and are not meant to imply any limitation on the invention or with respect to any of the general functions described within a particular section. Material presented in any one section may be applicable to a next section and vice versa. The following sequence of headings and subheadings are presented within the specification:
   A. General Architecture
   B. Cluster-Aware VIOS
   C. Autonomous Propagation of Virtual IO to Second VIOS Due to Fabric Loss
   D. Simultaneous Debugging

### A. General Architecture

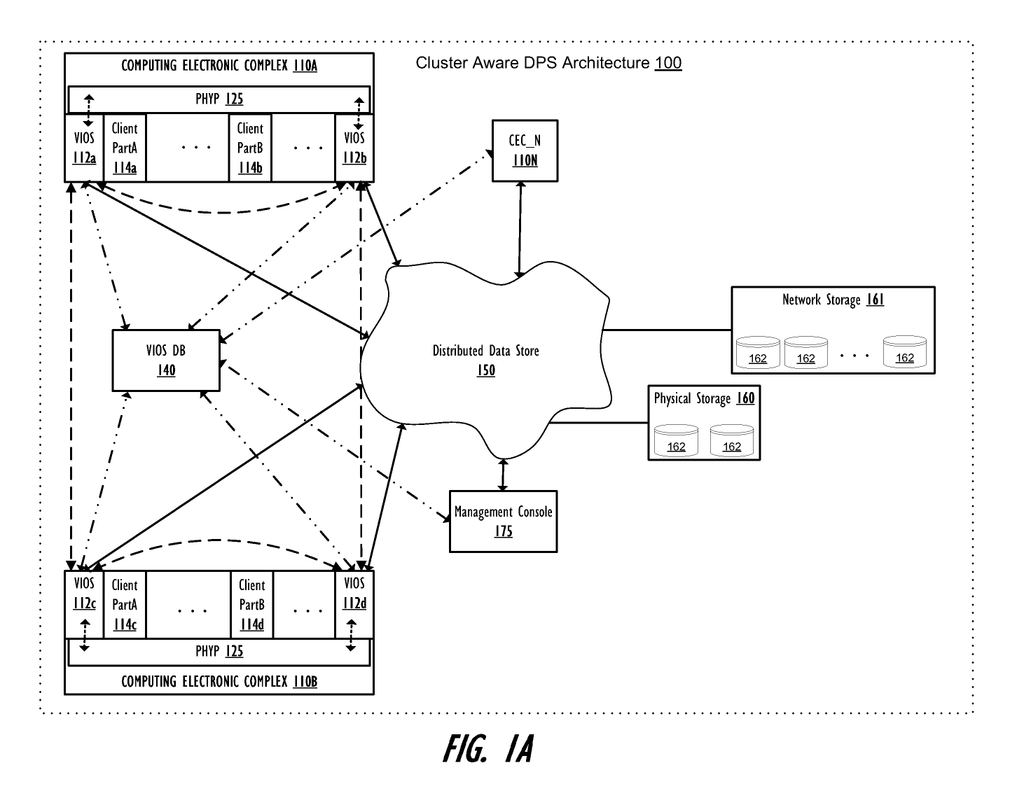

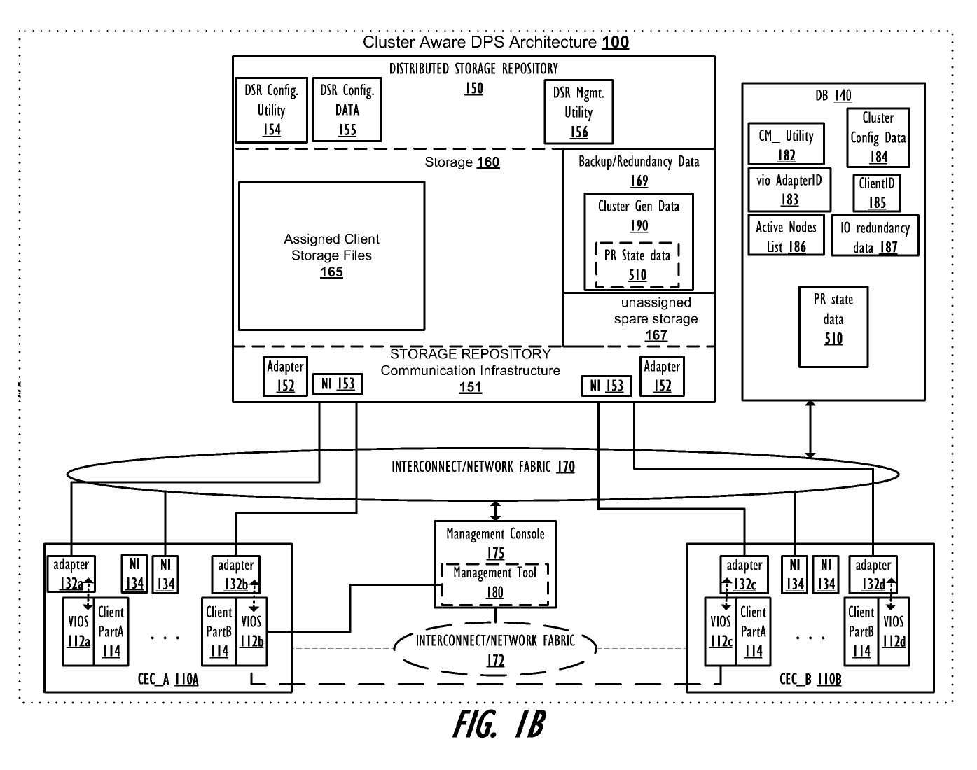

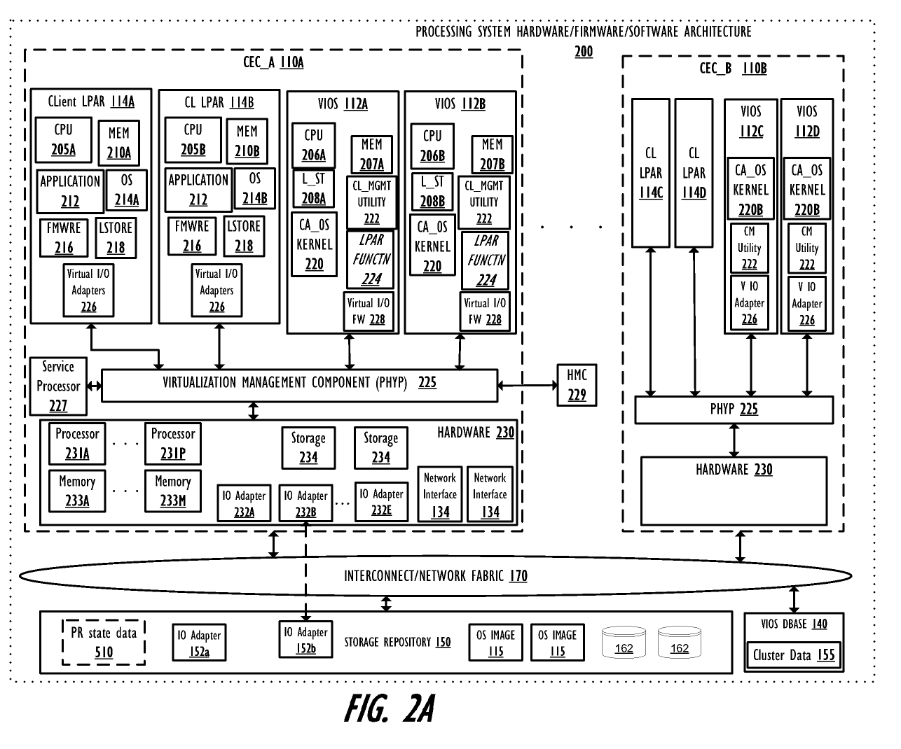

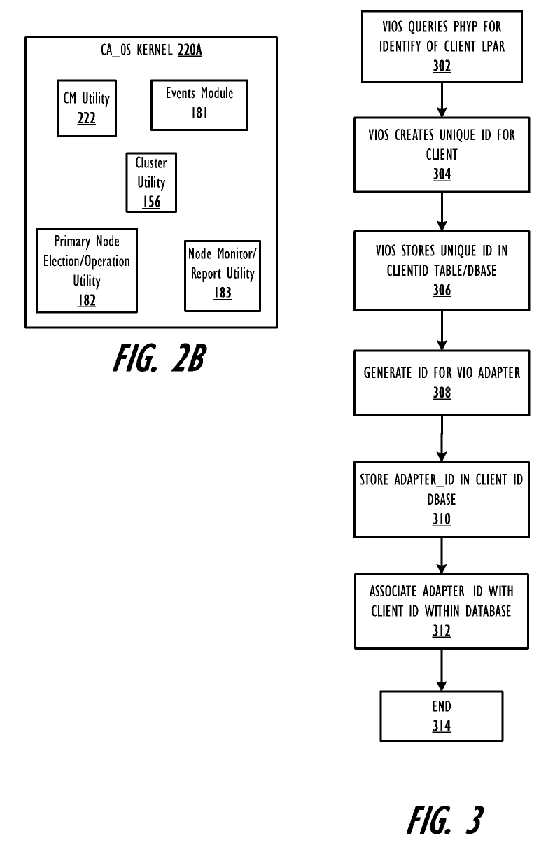

With specific reference now to FIG. 1A, there is depicted a block diagram of an example cluster-aware (CA), distributed data processing system (DPS) architecture 100, within which the functional aspects of the described embodiments may advantageously be implemented. For simplicity, cluster-aware, distributed DPS architecture 100 shall be referred to herein simply as DPS 100. DPS 100 comprises a plurality of computing nodes, each referred to herein as a computing electronic complex (CEC), of which CECs 110A and 110B are illustrated. The number of CECs within DPS 100 may vary, ranging from a single CEC in a smaller system extending up to hundreds or thousands of CECs, in larger scaled systems. For simplicity, the embodiments shall be described from the perspective of a single CEC (CEC 110A) or two CECs (CECs 110A, 110B). Each CEC 110A-110B comprises at least one (and in most instances a plurality of) Virtual Input/Output Server 112 (also referred to herein as a VIO Server or VIOS), with functionality as described below. The actual number of VIOSes 112 within each CEC 110 of DPS 100 is a design feature and may vary. Also supported within each CEC 110A-110B are client logical partitions (interchangeably referred to as client LPARs or “clients”), of which a first two clients, clientA 114a and clientB 114b, are illustrated. As described below, with reference to FIG. 2, client LPARs 114 are logical partitions of a virtualized (or operating system partitioned) computing system. The actual number of clients within each CEC 110 may vary and could range from a single client to hundreds or thousands of clients, without limitation. For efficiency in presenting the inventive concepts herein, only two clients are presented within each CEC 110 of the various illustrative and described embodiments.

DPS 100 also comprises a distributed storage facility, accessible to each of the CECs 110 and the components within the CECs 110. Within the described embodiments, the distributed storage facility will be referred to as distributed storage repository 150, and the distributed storage repository 150 enables several of the client level functional features provided by the embodiments described herein. Distributed storage repository 150 provides a single view of storage that is utilized by each CEC 110 and for each client 114 of each CEC 110 within a cluster-aware, distributed system. Distributed storage repository 150 comprises local physical storage 160 and network storage 161, both of which comprise multiple physical storage units 162 (e.g., disks. solid state drives, etc.). The physical disks making up distributed storage repository 150 may be distributed across a storage network (e.g., a SAN). Additionally, distributed storage repository 150 provides a depository within which is stored and maintained the software utility, instruction code, OS images, client images, data (system, node, and client level), and/or other functional information utilized in maintaining the client-level, system management, and storage-level operations/features of DPS 100. System Dump Images 404a-n for storing system dump data of one or more client LPARs 114a-n can also be stored in distributed storage repository 150. In addition to distributed storage repository 150, DPS 100 also comprises a VIOS database (DB) 140, which may also be a distributed storage facility comprising physical disks across a storage network. VIOS DB (or DB) 140 is a repository that stores and provides access to various cluster configuration data and other functional components/modules and data structures that enable the various cluster-aware functionality described herein. In one embodiment, portions of distributed storage repository 150 may be allocated to provide storage pools for a cluster. Each VIOS 112 of the cluster maintains a local view of the DB 140 and updates the cluster level information/data/data structures within DB 140 as such information/data is created or updated.

Communication between each VIOS 112 of each CEC 110 as well as with the VIOSes of at least one other CEC 110 is generally supported via a plurality of inter-CEC interconnects, illustrated as bi-directional, dashed lines connecting pairs of VIOSes 112. The arrows indicated two way data exchange or communication between components. In addition to the inter-CEC interconnects, each VIOS 112 is also connected to distributed storage repository 150 via VIOS-to-Store or CEC-to-Store interconnects, which are also illustrated as full lined bi-directional arrows. Also, each VIOS 112 is connected to DB 140 via VIOS-to-DB interconnects, presented as dashed and dotted lines. With the exception of the inter-CEC connectors running from a first VIOS (e.g., VIOS 112a) of a first CEC to a second VIOS (e.g., VIOS 112b) on the same CEC, the various interconnects represent a network level connectivity between the VIOS nodes of the cluster and the DB 140 and the distributed storage repository 150. As utilized herein, references to one or more “nodes”, are assumed to refer specifically to a VIOS within the cluster. DPS 100 also comprises a management console 175 on which a management tool (not shown) executes.

Turning now to FIG. 1B, there is illustrated another view of DPS 100 illustrating the network-based connection of the CECs 110 to the distributed storage repository 150 and DB 140. FIG. 1B illustrates in greater detail the network connectivity of VIOSes and CECs to each other and to Distributed storage repository 150. With this view, CEC_A (Node_A) 110A and CEC_B (Node_B) 110B comprise similar constructs as presented in FIG. 1A. Each CEC 110 within DPS 100 connects to distributed storage repository 150 via one or more networks and/or I/O interconnect/switch fabric (generally illustrated as interconnect/network fabric 170). The descriptions and illustrations assume that at least some of the CECs 110 of DPS 100 and distributed storage repository 150 are located remotely from each other, including being located in different countries, for example, such that no direct physical connectivity exists between the respective devices. For simplicity, the embodiments are described as having primary interconnect/network 170 comprising a private wide area network (WAN) or a public WAN (such as the Internet), although other network types (e.g., a local area network) are possible and supported.

As depicted, in one or more embodiments, each CEC 110 is also connected to one or more neighbor CECs 110, in order to provide efficient fail-over and/or mobility support and other functions, as described hereinafter. As utilized herein, the term neighbor refers to a connected second CEC with which a first CEC is able to communicate, and references to a neighbor CEC is not limited to a second CEC in geographic proximity to the first CEC. CEC_A 110A and CEC_B 110B are illustrated connected to each other via some connecting medium, which may include a different network (such as a local area network) 172 or some type of direct interconnect (e.g., a fiber channel connection) when physically close to each other. The connection between neighbor CECs 110A and 110B is illustrated as a direct line connection or a secondary network connection (172) between CECs 110A and 110B. However, it is appreciated that the connections are not necessarily direct, and may actually be routed through the same general interconnect/network 170 as with the other CEC connections to distributed storage repository 150. In one or more alternate embodiments, the connections between CECs may be via a different network (e.g., network 172, FIG. 1B), such as a local area network (LAN).

As depicted, each CEC 110 comprises one or more network interfaces 134 and one or more I/O adapters 132 to enable the CEC 110 and thus the other components (i.e., client partitions) of the CEC 110 to engage in network level communication, as illustrated by FIG. 1C. As illustrated within FIG. 1C, within an example virtual I/O architecture 190, each VIOS 112 emulates virtual client I/O adapters 226a-22c to enable communication by specifically-assigned client LPARs 114a-114c with distributed storage repository 150 and/or VIOS DB 140 and/or other clients, within the same CEC or on a different CEC. The VIOSes 112 emulate these virtual I/O adapters 226a-226c and communicates with distributed storage repository 150 by connecting with corresponding virtual server I/O adapters (SVA) 152a-152c at distributed storage repository 150. In various embodiments, these pairings of virtual client I/O adapters with specific SVAs are unique for each client LPAR 114 to enable each client LPAR 114 to have secure access to the specific storage location (366) assigned to that client LAPR 114. Internal CEC communication between VIOS 112 and client LPARs 114a-114c are illustrated with solid connecting lines, which are routed through the virtualization management component, while VIOS to server communication is provided by dashed lines, which connect via the network/interconnect fabric 172. The VIOSes 112 within each CEC 110 are thus able to support client level access to distributed storage 150 and enable the exchange of system level and client level information with distributed storage repository 150. Each client LPAR 114 has a unique client identifier (UCID). Also, each VIOS 112 has a specific DRC identifying the network location or address of the VIOS (or resources within the VIOS 112). Additionally, each VIOS has a universally unique identifier (UUID), which is associated with that particular VIOS configuration. Also shown by FIG. 1C is the connection of the management console 175, which is utilized to perform the setup and/or initialization of the backup and restore operations described herein for the individual VIOSes 112 and/or for the OS cluster as a whole, in various embodiments. Included within management console 175 and as utilized in the described embodiments, is management tool 180.

In addition, each VIOS 112 also comprises the functional components/modules and data to enable the VIOSes 112 within DPS 100 to be aware of the other VIOSes anywhere within the cluster (DPS 100). From this perspective, the VIOSes 112 are referred to herein as cluster-aware, and their interconnected structure within DPS 100 thus enables DPS 100 to also be interchangeably referred to as cluster-aware DPS 100. As a part of being cluster-aware, each VIOS 112 also connects to DB 140 via network 170 and communicates cluster-level data with DB 140 to support the cluster management functions described herein.

Also illustrated by FIG. 1B is an initial view of the component make-up of an example distributed storage repository 150 and an initial listing of some components of DB 140. To support the virtual I/O operations with the VIOSes 112 and the associated virtual client I/O adapters, distributed storage repository 150 comprises communication infrastructure 151. Communication infrastructure 151 comprises network interface(s) 153 and a plurality of server I/O adapters 152 utilized for cluster-level communication and enabling access to data/code/software utility stored on distributed storage repository 150 to complete I/O operations thereto. Specifically, these server I/O adapters are also presented as virtual sever I/O adapters 152a-c (see FIG. 1C), which are paired with respective virtual I/O adapters 226a-c (via emulation of physical I/O adapters 132) that are assigned to specific clients 114a-114c of CECs 110.

To support the virtual I/O operations with the VIOSes 112 and the associated virtual client I/O adapters, distributed storage repository 150 comprises communication infrastructure 151. Communication infrastructure 151 comprises network interface(s) 153 and a plurality of server I/O adapters 152 utilized for cluster-level communication and enabling access to data/code/software utility stored on distributed storage repository 150 to complete I/O operations thereto. Specifically, these server I/O adapters are also presented as virtual server I/O adapters, which are paired with virtual I/O adapters (132) that are assigned to clients 114 of CECs 110.

As shown with FIG. 1B, distributed storage repository (DSR) 150 also comprises a plurality of software, firmware and/or software utility components, including DSR configuration utility 154, DSR configuration data 155 (e.g., inodes for basic file system access, metadata, authentication and other processes), and DSR management utility 156.

To support the cluster awareness features of the DPS 100, and in accordance with the illustrative embodiment, distributed storage repository 150 also comprises VIOS database (DB) 140, in which is stored various data structures generated during set up and/or subsequent processing of the VIOS cluster-connected processing components (e.g., VIOSes and management tool). DB 140 comprises a plurality of software or firmware components and/or and data, data modules or data structures, several of which are presented in FIG. 1B, for illustration. Among these components are cluster management (CM) utility 182, VIO AdapterID data structure 183, cluster configuration data 184, Client identifying (ID) data 185, active nodes list 186, and I/O redundancy data 187, among others. These various components support the various clustering functionality and cluster-aware I/O operations of the one or more VIOSes 112, as described herein. Additional features of DB 140 and distributed storage repository 150 as well as the specific components or sub-components that enable the various clustering functionality are presented within the description of the remaining figures and throughout the description of the various embodiments.

These various data structures are created, maintained and/or updated, and/or deleted by the various operations of one or more of the processing components. In one embodiment, the initial set up of the storage pools, VIOS DB 240 and corresponding data structures is activated by execution of a cluster aware operating system by management tool 180. Once the infrastructure has been established, however, maintenance of the infrastructure, including expanding the number of nodes, where required, is performed by the VIOSes in communication with DB 140 and the management tool 180.

Also associated with DPS 100 and communicatively coupled to distributed storage repository 150 and DB 140 and VIOSes 112 is management console 175, which may be utilized by an administrator of DPS 100 (or of distributed storage repository 150 or DB 140) to access DB 140 or distributed storage repository 150 and configure resources and functionality of DB 140 and of distributed storage repository 150 for access/usage by the VIOSes 112 and clients 114 of the connected CECs 110 within the cluster. As shown in FIG. 1B and described throughout the specification, management tool 180 is implemented within management console 175. However, it is appreciated that (resources of) any node within DPS 100 may be selected/elected to perform the functions of management tool 180, and the selected node would then perform one or more of the below described cluster creation and the other cluster monitoring and management functions, utilizing the availability of the resources provided by DB 140 and distributed storage repository 150.

In an alternate embodiment, management tool 180 is an executable module that is executed within a client partition at one of the CECs within DPS 100. In one embodiment, the management tool 180 controls the operations of the cluster and enables each node within the cluster to maintain current/updated information regarding the cluster, including providing notification of any changes made to one or more of the nodes within the cluster.

With reference now to FIG. 2, there is presented a third view of an example DPS 100, emphasizing a processing system architecture 200 (i.e., architecture of the individual CECs, and specifically CEC_A 110A). CEC_A 110A (CEC 110A) serves as the example CEC that is described in greater detail in FIG. 2 and throughout the specification. CEC 110A is presented as a server that comprises hardware components and software/firmware/OS components that are logically partition to create a plurality of virtualized machine partitions, which are assigned as client logical partitions (LPARs) and virtual I/O servers (VIOSes). Hardware components 230 of example CEC 110A comprises one or more processors 231A-231P, one or more memories 233A-233M, and local storage 234. The processors 230A-230P are interconnected with one or a plurality of memories 233A-233M and with local storage 234 via a bus, interconnect/switch or an interconnect fabric (not specifically shown). The specific internal connectivity of components, which may be distributed across a large scale interconnect fabric, is not germane to the described embodiments, and no further detail is presented regarding the particular type of interconnectivity between the system hardware components.

Also included within hardware components 230 are one or more physical network interfaces 134 by which CEC_A 110A connects to an external network, such as network 170, among others. Additionally, hardware components 230 comprise a plurality of I/O adapters 232A-232E, which provides the I/O interface for CEC_A 110A. I/O adapters 232A-232E are physical adapters that enable CEC_A 110 to support I/O operations via an I/O interface with both locally connected and remotely (networked) connected I/O devices, including SF storage 150. Examples of I/O adapters include Peripheral Component Interface (PCI), PCI-X, or PCI Express Adapter, and Small Computer System Interconnect (SCSI) adapters, among others. CEC 110 is logically partitioned such that different I/O adapters 232 are virtualized and the virtual I/O adapters may then be uniquely assigned to different logical partitions.

Logically located above the hardware level (230) is a virtualization management component, provided as a Power Hypervisor (PHYP) 225 (trademark of IBM Corporation), as one embodiment. While illustrated and described throughout the various embodiments as PHYP 225, it is fully appreciated that other types of virtualization management components may be utilized and are equally applicable to the implementation of the various embodiments. PHYP 225 has an associated service processor 227 coupled thereto within CEC 110. Service processor 227 may be used to provide various services for one or more logical partitions. PHYP 225 is also coupled to hardware management controller (HMC) 229, which exists outside of the physical CEC 110. Operations of the different logical partitions may be controlled through HMC 229, which is a separate data processing system from which a system administrator may perform various functions, such as reallocation of resources to different logical partitions.

CEC_A 110A further comprises a plurality of user-level logical partitions (LPARs), of which a first two are shown, represented as individual client LPARs 114A-114B within CEC 110A. According to the various illustrative embodiments, CEC 110A supports multiple clients and other functional operating OS partitions that are “created” within a virtualized environment. Each LPAR, e.g., client LPAR 114A, receives an allocation of specific virtualized hardware and OS resources, including virtualized CPU 205A, Memory 210A, OS 214A, local firmware 216 and local storage (LStore) 218. Each client LPAR 114 includes a respective host operating system 214 that controls low-level access to hardware layer (230) of CEC 110A and/or to virtualized I/O functions and/or services provided through VIOSes 112. In one embodiment, the operating system(s) may be implemented using OS/400, which is designed to interface with a partition management firmware, such as PHYP 225, and is available from International Business Machines Corporation. It is appreciated that other types of operating systems (such as Advanced Interactive Executive (AIX) operating system, a trademark of IBM Corporation, Microsoft Windows®, a trademark of Microsoft Corp, or GNU®/Linux®, registered trademarks of the Free Software Foundation and The Linux Mark Institute) for example, may be utilized, depending on a particular implementation, and OS/400 is used only as an example.

Additionally, according to the illustrative embodiment, CEC 110A also comprises one or more VIOSes, of which two, VIOS 112A and 112B, are illustrated. In one embodiment, each VIOS 112 is configured within one of the memories 233A-233M and comprises virtualized versions of hardware components, including CPU 206, memory 207, local storage 208 and I/O adapters 226, among others. According to one embodiment, each VIOS 112 is implemented as a logical partition (LPAR) that owns specific network and disk (I/O) adapters. Each VIOS 112 also represents a single purpose, dedicated LPAR. The VIOS 112 facilitates the sharing of physical I/O resources between client logical partitions. Each VIOS 112 allows other OS LPARs (which may be referred to as VIO Clients, or as Clients 114) to utilize the physical resources of the VIOS 112 via a pair of virtual adapters. Thus, VIOS 112 provides virtual small computer system interface (SCSI) target and shared network adapter capability to client LPARs 114 within CEC 110. As provided herein, VIOS 112 supports Virtual real memory and Virtual shared storage functionality (with access to Distributed storage repository 150) as well as clustering functionality.

Within CEC 110A, VIOSes 112 and client LPARs 114 utilize an internal virtual network to communicate. This communication is implemented by API calls to the memory of the PHYP 225. The VIOS 112 then bridges the virtual network to the physical (I/O) adapter to allow the client LPARs 114 to communicate externally. The client LPARs 114 are thus able to be connected and inter-operate fully in a VLAN environment.

Those of ordinary skill in the art will appreciate that the hardware, firmware/software utility, and software components and basic configuration thereof depicted in FIGS. 1A, 1B, 1C, and 2 may vary. The illustrative components of DPS 100 and specifically those within CEC 110A are not intended to be exhaustive, but rather are representative to highlight some of the components that are utilized to implement certain of the described embodiments. For example, different configurations of data processing systems/CECs devices may be provided, containing other devices/components, which may be used in addition to or in place of the hardware depicted, and may be differently configured. The depicted example is not meant to imply architectural or other limitations with respect to the presently described embodiments and/or the general invention. The CEC 110 depicted in the various figures may be, for example, an IBM eServer pSeries system, a product of International Business Machines Corporation in Armonk, N.Y., running the Advanced Interactive Executive (AIX) operating system or LINUX operating system.

### B. Cluster-Aware VIOS

Certain of the features associated with the implementation of a cluster aware VIOS (e.g., VIOS 112 of FIGS. 1A, 1B and 2) are introduced above with reference to the description of the previous figures, and particularly FIG. 2. Descriptions of the specific functionality of the VIOS 112 will continue to be provided with reference to the illustrations of FIGS. 1A, 1B and 2. As presented by FIG. 2, each VIOS 112 is a virtual machine instance that emulates hardware in a virtualized environment. The VIOS 112 is tasked with emulating SCSI storage devices, and the VIOS 112 provides client LPARs 114 with access to distributed storage repository 150 in cooperation with the PHYP 225. Configuration of the VIOS 112 is performed through the hardware management tools of HMC 229. SCSI storage devices support a set of commands that allow SCSI initiators the ability to control access to storage (150). Database programs, for example, may manage access to distributed storage repository 150 through a set of SCSI commands commonly referred to as persistent reserve. Other types of reserves are also supported by VIOS 112, and the collective group of such commands is referred to herein as reserve commands.

As provided herein, each VIOS 112 allows sharing of physical I/O resources between client LPARs, including sharing of virtual Small Computer Systems Interface (SCSI) and virtual networking These I/O resources may be presented as internal or external SCSI or SCSI with RAID adapters or via Fibre-Channel adapters to distributed storage repository 150. The client LPAR 114, however, uses the virtual SCSI device drivers. In one embodiment, the VIOS 112 also provides disk virtualization for the client LPAR by creating a corresponding file on distributed storage repository 150 for each virtual disk. The VIOS 112 allows more efficient utilization of physical resources through sharing between client LPARs, and supports a single machine (e.g., CEC 110) to run multiple operating system (OS) images concurrently and isolated from each other.

In one or more embodiments, the VIOS operating system(s) is an enhanced OS that includes cluster-aware functionality and is thus referred to as a cluster aware OS (CA_OS). One embodiment, for example, utilizes cluster aware AIX (CAA) as the operating system. According to one embodiment, cluster-awareness enables multiple independent physical systems to be operated and managed as a single system. As provided within VIOS 112 of CEC 110A, VIOS 112 comprises cluster aware (CA) OS kernel 220 (or simply CA_OS 220), as well as LPAR function code 224 for performing OS kernel related functions for the VIOS LPARs 114. When executed within two or more nodes of DPS, CA_OS 220 enables various clustering functions, such as forming a cluster, adding members to a cluster, and removing members from a cluster, as described in greater detail below. CA_OS 220 manages the VIOS LPARs 112 and enables the VIOSes within a cluster to be cluster aware. CA_OS 220 comprises several functional modules. In the described embodiments, CA_OS 220 comprises cluster management (CM) utility 222 which supports the configuration of the VIOS to enable cluster-awareness and cluster-level functionality, such as redundant virtual I/O. Each of these additional software components of CA_OS 220 may be a functional module within CM utility, in one embodiment, and each module is thus described as such throughout the remainder of this specification. In one embodiment, CM utility 222 may be a separate utility that is locally installed or downloaded (from DB 140, for example) as an enhancement to an existing OS within a CEC 110 or VIOS 112, when initially configured for operation within the VIOS cluster. CM utility 222 is then executed when configuring the individual VIOS to create or join a cluster and/or become a cluster-aware node within the VIOS cluster. With this implementation structure, CM utility 222 enables the OS to support the various cluster-awareness and other cluster-level features and functionality. In an alternate embodiment, CA_OS 220 includes all the clustering features and functionality and established the various features when the CEC 110/VIOS 112 joins the cluster and/or during configuration of VIOS 112 to become cluster-aware.

In one implementation, functional components of CM utility 222 are encoded on local device storage of a corresponding VIOS 112, such that the VIOS 112 becomes automatically configured as a part of the VIOS cluster when the VIOS 112 is initially activated. On initial set up of the VIOS, VIOS API, kernel extensions and virtual adapters are configured within VIOS to enable communication with the other VIOSes, the VIOS DB 140, and with the distributed storage repository 150. During this initial setup of the VIOS 112, the VIOS executes a registration module of CM utility 222 to register VIOS 112 with the cluster. The registration module enables VIOS 112 to retrieve/download or have forwarded from DB 140 (on successful registration with the cluster) any additional CM software components and/or cluster-level information and/or data required to establish full cluster awareness when the VIOS has completed installation and is activated within the CEC 110. Thus, in one embodiment, in addition to the locally stored CA_OS components and software modules of CM utility 222, other functional components of CM utility 222 may be downloaded from DB 140 when CEC is powered on or when one or more VIOSes 112 are enabled on CEC 110. Once the VIOS 112 has completed its setup, one or more client LPARs 114 that are activated within CEC 110 may be assigned to VIOS 112, and VIOS 112 subsequently performs the various I/O operations initiated by the client 114 (as initiator) or directed to the client 114 (as target). Updates to the local VIOS data may periodically be made as changes are made within the VIOS cluster and/or as one or more new client LPARs 114 are added to the CEC 110 requiring VIOS support. In one embodiment, CM utility 222 may also enable retrieval and presentation of a comprehensive view of the resources of the entire cluster.

It is appreciated that while various functional aspects of the clustering operations are described as separate components, modules, and/or utility and associated data constructs, the entire grouping of different components/utility/data may be provided by a single executable utility/application, such as CA_OS 220 or CM utility 222. Thus, in one embodiment, CA_OS 220 executes within VIOS 112 and generates a plurality of functional components within VIOS 112 and within DB 140. Several of these functional components are introduced within FIG. 1B and FIG. 2 and others are described throughout the various embodiments provided herein. For simplicity in the descriptions which follow, references to CM utility 222 and CA_OS 220 will be assumed to be referring to the same general component (i.e., CM utility 222 being a subcomponent of CA_OS 220), and the terms may be utilized interchangeably throughout the specification.

As further presented by the illustrative embodiments (e.g., FIG. 2A), VIOS 112 includes one or more additional functional modules/components, such as VIO adapter(s) (interface) 226, and virtual I/O drivers/utility 228, which provides I/O functionality to VIOS 112 and enables VIOS 112 to route data traffic to and from data structures and storage within distributed storage repository 150 and/or DB 140. Virtual I/O adapter(s) 226 and CM utility 222 also enable the VIOS 112 to provide each client LPAR 114 with access to the full range of storage accessible within distributed storage repository 150 and other cluster-supported functionalities, as described herein.

In the illustrative embodiment, each client LPAR 114 communicates with VIOS 112 via PHYP 225. VIOS 112 and client LPAR 114A-114B are logically coupled to PHYP 225, which enables/supports communication between both virtualized structures. Each component forwards information to PHYP 225, and PHYP 225 then routes data between the different components in physical memory (233A-233M). In one embodiment, a virtualized interface of I/O adapters is also linked to PHYP 225, such that I/O operations can be communicated between the different logical partitions and one or more local and/or remote I/O devices. As with local I/O routing, data traffic coming in and/or out of I/O adapter interface or network interface from a remote I/O device is passed to the specific VIOS 112 via PHYP 225.

With the above introduced system configuration of FIGS. 1A, 1B and 2A, a first VIOS 112a (through a communication channel established via PHYP 225), grants access to another VIOS 112b through one or more virtual adapters. VIOS 112 includes the functionality to query PHYP 225 for the identity of the Client LPAR 114 on the CEC 110 where the VIOS 112 is currently running.

With the cluster aware VIOS infrastructure, different VIOSes 112 associated with different CECs 110 access the distributed storage repository 150 and cluster-level information is shared/communicated across the VIOS cluster (via VIOS DB 140) while each client I/O process is being performed. In this manner the VIOS associated with a first client on a first CEC is aware of which SAN disk resources are being accessed by a second client on a second CEC (or on the same CEC). With this awareness factored into the I/O exchange with the distributed storage repository 150, the VIOS associated with the first client can avoid accessing the same storage resource that is concurrently being utilized by the second client, thus preventing data integrity issues, which could potentially cause data corruption and client partition crashes.

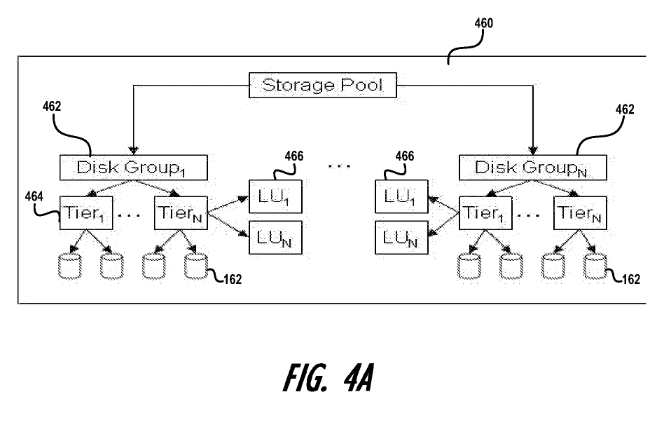

In one embodiment, VIOS functionality is enhanced to enable assigning of client identifiers (ID) and unique virtual I/O adapter IDs in a secure manner, while enabling storage pooling within virtual storage (within distributed storage repository 150). According to the described implementation, the different clientID-vioAdapterID pairings are unique throughout the cluster, so that no two clients throughout the entire cluster can share a same virtual adapter and no two vioAdapterIDs are the same within a single client. FIG. 3 is a flow chart illustrating the method by which a VIOS 112 on a CEC 110 with DPS 100 enables cluster level communication between a client LPAR 114 and distributed storage repository 150, according to one embodiment. The process begins at block 302 at which the VIOS 112 queries PHYP 225 for the identity of the client LPAR 114. At block 304, the VIOS 112 creates a unique identifier (ID) for the client (i.e., a ClientID). The VIOS 112 then stores the unique ClientID in ClientID data structure 159 (FIG. 1B) within DB 140 (block 306). The DB 140 and by extension the ClientID data structure 159 are accessible to each VIOS partition in the cooperating cluster (DPS 100). At block 308, the VIOS 112 also generates an identifier for each virtual IT nexus (virtual I/O AdapterID) that is utilized for each virtual adapter assigned to the client LPAR 114. In one embodiment, a client LPAR 114 can have multiple virtual adapters assigned thereto. These vio AdapterIDs are stored in the AdapterID data structure 158 (block 310) and are associated with their corresponding clientIDs (block 312). The method illustrated by FIG. 3 ends at termination block 314, with each clientID having been associated with the corresponding one or more vio AdapterIDs with DB 140.

As described herein, a cluster is a set of one or more networked VIOS partitions, where each VIOS within the cluster has access to a common set of physical volumes. The physical volume resides within the VIOS cluster and is utilized to provide block storage. Implementation of the cluster awareness with the VIOSes of the cluster enables the VIOSes to provide cluster storage services to virtual clients (client LPARs 114). The VIOS software stack provides the following advanced capabilities, among others: Storage Aggregation and Provisioning; Thin Provisioning; Virtual Client Cloning; Virtual Client Snapshot; Virtual Client Migration; Distributed Storage Repository; Virtual Client Mirroring; and Server Management Infrastructure integration. More generally, the VIOS protocol allows distributed storage to be viewed as centralized structured storage with a namespace, location transparency, serialization, and fine grain security. The VIOS protocol provides storage pooling, distributed storage, and consistent storage virtualization interfaces and capabilities across heterogeneous SAN and network accessible storage (NAS). In order to provide block storage services utilizing the distributed repository, each VIOS configures virtual devices to be exported to virtual clients. Once each virtual device is successfully configured and mapped to a virtual host (VHOST) adapter, the clients may begin utilizing the devices as needed. In one embodiment, the virtualization is performed utilizing POWER™ virtual machine (VM) virtualization technology, which allows the device configuration process to occur seamlessly because the physical block storage is always accessible from the OS partition.

### C. Redundant Virtual IO Operations

According to one embodiment, to take advantage of the clustered VIOS configuration whereby multiple VIOSes have access (or can gain access) to a shared block storage (such as the distributed storage repository 150), virtual clients (client LPARs 114) are configured with redundant access to multiple VIOSes. With this ability to provide client LPARs 114 with redundant access to multiple VIOSes, the described embodiments further enable a reduction in I/O errors that would otherwise be caused by a loss of connectivity to the network fabric by any one VIOS supporting I/O operations of a client LPAR 114. Thus, as described in greater detail below, a first VIOS partition that is currently servicing I/O requests from an initiator (client LPAR 114) can propagate I/O resources to other VIOSes within the VIOS cluster, such that a second VIOS can service the I/O request, where backup I/O servicing is needed.

The below described embodiments are implemented within the various configurations of DPS 100 (FIGS. 1-2) having VIOSes 112 of one or more CECs 110 arranged in a VIOS cluster and supporting the I/O operations of the client LPARs located on the one or more CECs 110. As provided herein, the VIOSes are cluster aware and share cluster-level data via VIOS DB 140. Further, the VIOSes 112 provide the VIO operations that enable access to distributed storage repository (storage repository) 150. The various presented embodiments further provide application of management tool (180) functionality and descriptions of the messaging and communication protocols (of the clustered VIOSes 112) that collectively enable cluster- awareness and efficient I/O and storage virtualization and I/O and storage management within the DPS. As is described hereinafter, additional embodiments enable VIO operations to be autonomously propagated from a first VIOS to a second VIOS of the VIOS cluster following a fabric loss of the client-assigned (first) VIOS handling the VIO for the client LPAR. These embodiments are supported/provided by additional functionalities of (i.e., encoded within) the CA_OS 220 and/or specifically CM utility 222.

CM utility 222 is executed by virtual processing resources of VIOS 112 to provide a method for enabling the various I/O redundancy features and functionality described by the below presented embodiments. Among the method functions performed/provided by execution of the I/O redundancy module/code of the CM utility 222 are the following non-exclusive functions: (a) a first VIOS receiving an I/O request from the client LPAR; (b) detecting that a problem exists with a communication connection to the block storage; and (c) in response to detecting that the problem exists, autonomously propagating the I/O request to a second VIOS to which the first VIOS is connected within the VIOS cluster, wherein forwarding of the I/O request to the block storage is completed by the second VIOS.

Additional functions performed by the method include: receiving an I/O response from the second VIOS; identifying that the I/O response is associated with the I/O request that was propagated to the second VIOS; and in response to the I/O response being associated with the I/O request, forwarding the I/O response to the client LPAR. According to one embodiment, the propagating of the I/O request to the second VIOS further comprises: forwarding a first cluster-level request message to the second VIOS requesting the second VIOS take over handling of the I/O request; receiving a first cluster-level response message indicating that the second VIOS can handle the I/O request; and propagating the I/O request responsive to receiving the first cluster-level response message. Additionally, in a next embodiment, propagating of the I/O request to the second VIOS further comprises: receiving a second cluster-level response message indicating that the second VIOS cannot take over handling of the I/O request; and identifying a third VIOS within the VIOS cluster; forwarding a second cluster-level request message to the third VIOS; and autonomously propagating the I/O request to the third VIOS in response to receiving confirmation from the third VIOS that the third VIOS can handle the I/O request.

One embodiment provides a computer program product having a computer readable storage medium; and program code on the computer readable storage medium that when executed by a processor within a data processing system performs a series of functions including: creating within a virtualized environment, a first virtual input/output (I/O) server (VIOS) that handles I/O operations of a client logical partition (LPAR) generated within the virtualized environment of the data processing system; creating a VIOS cluster with the first VIOS and one or more second VIOSes located within the CEC, where each VIOS within the VIOS cluster are communicatively coupled to each other VIOS within the VIOS cluster; and enabling each VIOS within the VIOS cluster to provide virtual I/O (VIO) connectivity to a physical fabric connecting the VIOS to the block storage.

### D. Simultaneous Debugging

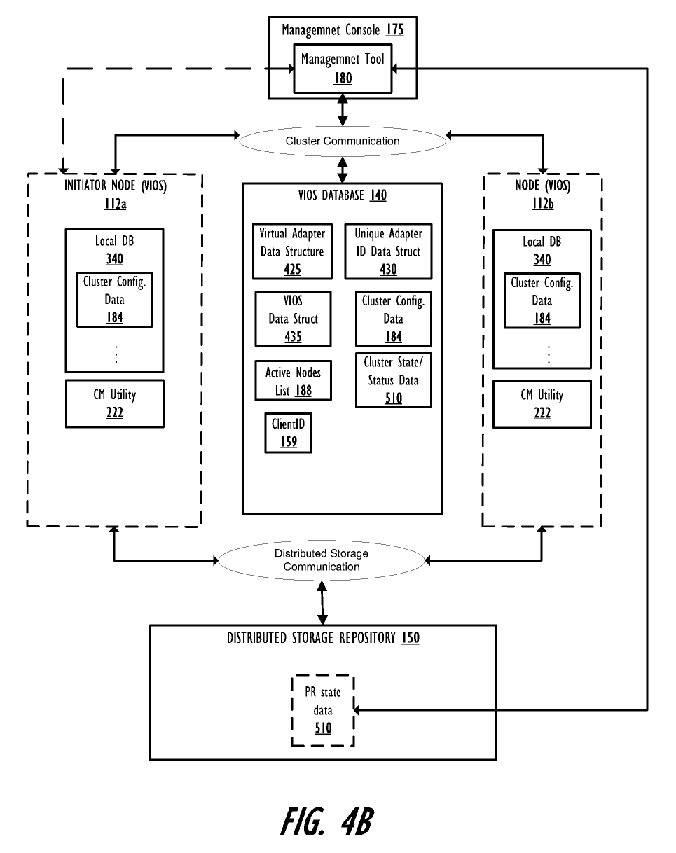

With the above described configurations of a DPS 100 configured with distributed storage repository 150, DB 140, and CECs 110 having VIOSes that are clustered and/or cluster aware through use of DB 140, additional embodiments are provided to enable efficient storage virtualization and management utilizing the VIOSes 112 described above. Implementation of these additional embodiments may involve additional functional components (utilities) of the CA_OS 220 and/or specifically CM utility 222. According to one or more embodiments, the CM utility 222 also enables active memory sharing of a same storage device within the distributed storage repository by one or more VIOSes 112. Within the distributed storage repository, all the storage devices are virtualized into a large storage pool where chunks of storage units also known as logical units (LUs) (e.g., LUs 402a-n of FIG. 4) can be carved out and assigned as paging devices for each client. Each client is able to utilize an assigned LU as a paging file thereby facilitating sharing of the storage device and reduce wastage. PHYP 225 provides an interface between a client LPAR and a VIOS and supports/enables various storage I/O operations such as moving or pulling data for one or more VIOSes 112 accessing the LUs. A same LU may be used/accessed by one or more client LPARs 114 owned by the same client via one or more VIOSes 112 of one or more CECs 110. For security purposes, however, a client is unable to access a LU belonging to another client.

In one implementation, certain functional components of CM utility 222 are encoded on local device storage accessible to corresponding VIOS 112. VIOS 112 is able to immediately register with the cluster and retrieve/download, or have forwarded from DB 140 (on successful registration with the cluster), the necessary CM software, information, and/or data the VIOS utilizes to become cluster aware when the VIOS is initially activated within the CEC 110. In addition to the locally stored software utility components of CM utility 222, other functional components of CM utility 222 may be downloaded from DB 140 when CEC 110 is powered on or when one or more VIOSes 112 and/or one or more new client LPARs 114 are enabled by PHYP 225 on CEC 110. A utility may comprise firmware and or specially stored OS code on the CEC that allows for cluster specific boot up and/or setup of a VIOS within the cluster.

Management tool 180 (and/or LRUs 416a-n) provides code/program instructions that are executed on one or more virtual processor resources of one or more VIOSes 112 within CEC 110 to provide specific functions. Among the functionality provided by Management tool 180 when executed and which are described in greater details herein are the following non-exclusive list: (1) receiving a terminal debugging session request from a management console interface of a management console; (2) in response to receiving the terminal debugging session request, starting a debugger instance; (3) receiving a cluster selection via the management console interface, wherein the cluster selection identifies a selected VIOS cluster which has a plurality of client logical partitions (LPARs),each client LPAR having a system dump image stored within a distributed storage repository of the cluster-aware data processing system; (4) the debugger instance receiving, from the management console interface, a selection of a first client LPAR and a second client LPAR from the one or more client LPARs for analysis; (5) analyzing a first system dump image and a second system dump image, wherein the first system dump image is the system dump image associated with the first client LPAR, and wherein the second system dump image is the system dump associated with the second client LPAR; and (6) concurrently providing a first analysis of the first system dump image and a second analysis of the second system dump image to the management console interface.

FIG. 4 is a block diagram illustrating the usage of a management console for providing simultaneous debugging of multiple system dump pairs in a cluster environment. The CA VIOS protocol builds on existing virtual SCSI (VSCSI) technology to provide distributed storage across clustered VIOS partitions. The cluster environment treats all storage on the server system as one big “virtual” storage pool with chunks of storage (partitions) LUs 402a-n allocated to client LPARs (e.g., LPARs 114-a-n). In one embodiment, specific LUs may be allocated to hold and store system dump images 404a-n of operating systems or operating system kernels (e.g., CA_OS 220) and contain OS images and/or system dump pairs. In another embodiment, LPARs 114a-n may utilize sub partitions of LUs 402a-n for storing OS images and/or system dump pairs. VIOSes 112a-n perform the store/dump operations to the distributed storage repository 150. One or more OS images and/or system dump pairs are capable of being analyzed by a single debugger instance 414 of management console 175.

In one embodiment, management console 175 is a data processing system that includes management tool 180 for providing an interface between a support personnel and a debugger instance 414 serving a plurality of client LPARs 114a-n. In another embodiment, management console 175 is a component within a client partition at one of the CECs that provides the functionality provided herein. Management console 175 contains one or more logical reasoning utilities (LRUs) 416a-n and management console interface (MCI) 412. LRUs 416a-n provide relational LPAR system state analysis identification and calculation/comparison as extensions of debugger instance 414. LRUs 416a-n may be dynamically loaded, as needed, and also further provides for identifying common system state data between the nodes currently loaded in the debugger. In one embodiment, management console 175 connects to a VIOS 112 node in a VIOS cluster via a connection with PHYP 225. Management console 175 may interface with CM Utility 222 and/or any VIOS nodes.

Debugger instance 414 is a kernel debugger that allows loading of multiple kernel images simultaneously into one debug session. In one or more embodiments, debugger instance 414 is enhanced to allow client LPAR level context image switching in real time. Debugger instance 414 enables storage, retrieval and analysis of multiple system dump images 404 within one debug session. Real time switching reduces the need to have multiple different debug sessions going on at once. In one embodiment, after debugger instance 414 is connected with a PHYP 225. Debugger instance 414 may provide instructions to CM Utility 222 or a VIOS 112 to retrieve/pull system dump images 404a-n from distributed storage repository 150 to the debugger instance 414. Debugger instance 414 may be a cluster aware (CA) AIX kernel debugger tool (KDB), in one embodiment.

MCI 412 provides a console interface for enabling interaction/management of debugger instance 414 by support personnel. MCI 412 can receive requests and/or commands from a support personnel. In one embodiment, MCI 412 can display analyses and relational information received from debugger instance 412 for viewing on a display (e.g., display 720) of management console 175.

System state data (not pictured) is a sub-portion of data within a system dump image 404. System state data may contain forensic information of the system dump image, context information for one or more central processing units (CPUs) of a client LPAR, a memory context information for the client LPAR 114 or VIOS 112, crash information of one or more client LPARs 114 or VIOSes 112, or a combination of one or more of the preceding list of forensic information. Debugger instance 414 uses a selection of one or more system dump images 404, system state data, and LRUs 416a-n to calculate an analysis 418 for each system dump images 404. Debugger instance 414 may also compare two or more analyses 418a-n of different system dump images 404 to determine relational information 419. The relational information may compare and/or contrast differences and/or similarities between analyses 418a-n. Multiple analyses and/or relational information may be concurrently debugged, analyzed, and/or displayed for management console 175 by a single debugger instance 414. These differences and similarities can be used by another utility or by support personnel to troubleshoot or analyze/diagnose operations of one or more CECs 110, one or more LPARs 114, and/or one or more VIOSes 112. The client LPARs may comprise all client LPARs 114 within the cluster-aware data processing system.

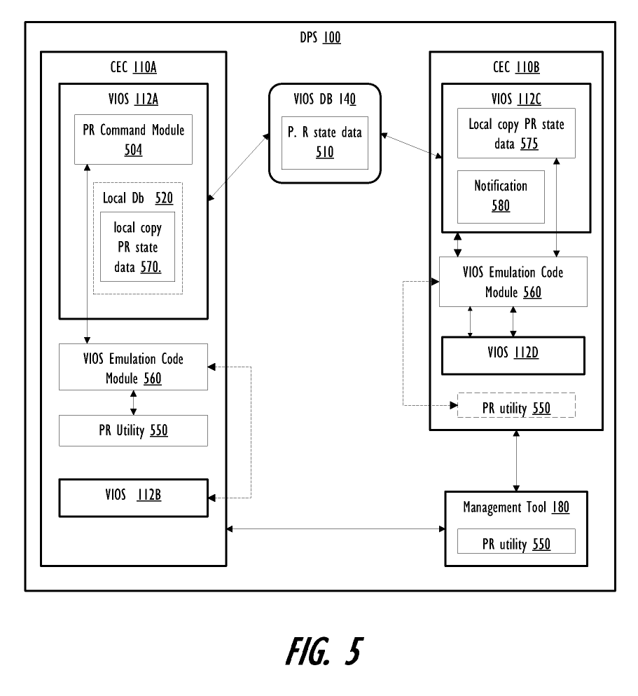

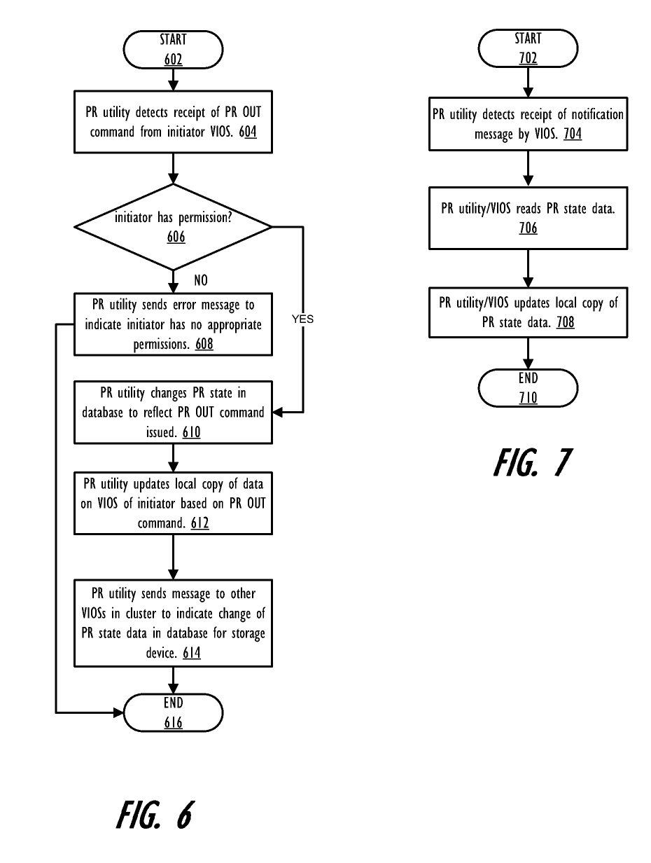

FIGS. 5-6 are flow charts illustrating various methods by which the above processes of the illustrative embodiments are completed. Although the methods illustrated in FIGS. 5-6 may be described with reference to components and functionality illustrated by and described in reference to FIGS. 1-4 it should be understood that this is merely for convenience and alternative components and/or configurations thereof can be employed when implementing the various methods. Certain portions of the methods may be completed by a debugger instance 114 (and/or via logic provided by LRUs 416a-n) of management console 175 (as part of the management tool 180, in one embodiment) or via processing resources of CEC 110. Debugger instance 114 connects to one VIOS via PHYP to retrieve system dump images and/or information contained in a system dump image from the distributed storage repository. The executed processes then control specific operations of or on CECs 110, client LPARs 114, VIOSes 112, LRUs 416, or distributed storage repository 150. For simplicity in describing the methods, all method processes are described from the perspective of management console 175 and/or management tool 180 and/or LRUs 416a-n.

With reference now to FIG. 5 there is a high-level logical flowchart of an exemplary method for providing simultaneous debugging of multiple system dump images in a cluster environment, according to one embodiment. At block 504 management console 175 receives a terminal debugging session request at MCI 412. In one embodiment, the terminal debugging session request is input by a support personnel to MCI 412. In response to receiving the terminal debugging session request, management console 175 may start a new debugger instance 414 (block 506). Management console 175 then receives a cluster selection via MCI 412 (block 508). The cluster selection identifies a selected VIOS cluster with the cluster-aware environment. Each cluster comprises of one or more client LPARs 114. Each client LPAR 114 specified in the request has a system dump image 404 allocated and/or stored within distributed storage repository 150 of the cluster-aware data processing system. In response to receiving the cluster selection, debugger instance 414 autonomously identifies at least a first and a second client LPAR from the one or more client LPARs 114 in the selected cluster for analysis (block 510). The first and second client LPARs may be selected by a support personnel within the debugging session request or may be autonomously identified responsive to an event at those client LPARs (such as a crash). The management tool 180 then identifies, via a connection with PHYP, a first and a second system dump image associated with the first and second client LPARs, respectively (block 512). The system dump images assigned to the first and a second client LPARs 114 are then pulled/loaded onto local memory of management console 175 (block 514). At block 516, the first and second system dump images are then concurrently analyzed by the same debugger instance 414 (and/or via LRUs 416a-n).

Upon completion of the analysis of the first and second system dump images the resultant analyses of the first and second system dump images are loaded to MCI 412 (block 518). Debugger instance 414 can then determine/evaluate relational information 419 from the first analysis 404a and second analysis 404b via one or more LRUs 416a-n (block 520). Relational information identifies similarities or differences of the data contained in the analyses of the first and second system dump images and may be further compared via logic provided by debugger instance 414 and/or via LRUs 416a-n. The determined relational information can then be loaded by debugger instance 414 to the MCI 412 (block 522). At block 524 the relational information and the analyses of the first and second system dump images can be simultaneously viewed and/or toggled between by a support personnel utilizing the management console. The process terminates at block 530.

With reference again to FIG. 4, the debugger instance 414 may also determine one or more similarities and/or differences between the system state data of the first system dump image 404a and the second system dump image 404b. The relational information 419 provided to MCI 412 may then also include a new analysis of one or more similarities and/or differences between the first system dump image 404a and the second system dump image 404b. This enables analysis support personnel and/or logic in the cluster environment to troubleshoot or analyze/diagnose operations of one or more CECs 110, one or more LPARs 114, and/or one or more VIOSes 112.

In FIG. 6 there is depicted a high level logical flowchart of a method for determining similarities and/or differences between system dump relational information of system dump pairs in a cluster environment, according to one embodiment. In one embodiment, the method provided in FIG. 6 can be a sub-routine of block 526 of FIG. 5.

After initiator block 602, Debugger instance 414 determines relational information 419 from the first system dump image 404a and second system dump image 404b (block 604). Debugger instance 414 then makes a determination if it is desired (either by logic or by a user interacting with MCI 412) to analyze similarities between first system dump image 404a and second system dump image 404b (block 606).

When the determination is made at block 606 that it is not desired to analyze similarities between first system dump image 404a and second system dump image 404b, debugger instance 414 determines one or more differences of first system dump image 404a and second system dump image 404b (block 620). Debugger instance 414 then provides to MCI 412 the resulting analysis of the one or more differences between first system dump image 404a and second system dump image 404b (block 622). The process then terminates at block 630. When the determination is made that it is desired to analyze similarities between first system dump image 404a and second system dump image 404b, the process continues to block 610 where the debugger instance 414 determines one or more similarities between first system dump image 404a and second system dump image 404b (block 610). Debugger instance 414 then provides to MCI 412 the resulting analysis of the one or more similarities between first system dump image 404a and second system dump image 404b (block 612). A determination is then made if it is desired (either by logic or by a user interacting with MCI 412) to analyze the differences of first system dump image 404a and second system dump image 404b (block 614). When the determination is made that it is desired to analyze differences of first system dump image 404a and second system dump image 404b, the continues to block 620. When the determination is made that it is not desired to analyze differences of first system dump image 404a and second system dump image 404b, the process then terminates at block 630.

According to one or more embodiments, and as illustrated by FIG. 7, LRUs 414a-n and debugger instance 414 are implemented as a part of the management tool 180 within management console 175. Other embodiments can provide for LRUs 414a-n to be located within or associated with the PHYP 225. Referring now to FIG. 7, there is illustrated a data processing system with hardware and software components that can be utilized to simultaneously debug multiple OS image and/or system dump images in a cluster environment from a single management console, according to one or more embodiments. The illustrated processing system provides/supports the functionality of an example management console and is therefore referred to herein as management console 175, for consistency. It is appreciated that the physical configuration of management console 175 may be different from that illustrated in FIG. 7, and the specific configuration presented herein is provided for illustrative purposed only.

As illustrated, management console 175 comprises a processor 702, which is communicatively coupled to local memory 706 and I/O controller/bridge 710 via system bus/interconnect 704. I/O controller/bridge 710 has an associated I/O bus to which is connected one or more I/O devices, of which keyboard 714 and pointing device 716 (e.g., mouse), and display 720 are illustrated. Display 720 connects to I/O bus 712 via a graphics/display adapter 718. Also connected to I/O bus 712 are network interface 722 and I/O adapter 724. Network interface enables connection to an external network, such as is illustrated by network fabric 170 (FIGS. 1A-1C). I/O adapter 724 can be any I/O adapter that enables I/O interfacing with an I/O device and/or another data processing system, such as CEC 110 (FIGS. 1A-1C and 2). Management console 175 further includes a storage device 730 within which instructions/code/data related to processes on the management console may be stored.

In addition to these hardware components, located within local memory 706 are a plurality of software components that enable management console 175 to function as a management device within a VIOS cluster environment. Among these software components are local OS 708, management tool 180, and MCI 412. Management tool 180 as previously described supports/provides certain of the functions related to management of a VIOS cluster, including initiating the set up the individual client LPARs, assigned to specific clients, and overall management functions associated with the client LPARs and the VIOSes on a CEC or within the VIOS cluster. Specific to the presently described embodiments, management tool 180 provides/comprises LRUs 416a-n, which execute on processor 702 to provide a plurality of functions associated with simultaneous debugging of OS and/or system dump images from a single debugger instance 414. Communication of the management tool 180 (and/or LRUs 416a-n and debugger instance 414) functions to the VIOSes can be accomplished via the virtualization management component (PHYP) 225, in one embodiment. MCI 412 provides an interface between debugger instance 414 and a user of management console 175. Portions of MCI 412 may be viewable on display 720. In one embodiment, MCI 412 can receive input from a user of MCI 412 via keyboard 714 and pointing device 716.

In the provided embodiments, some of the features of or LRUs 416a-n and debugger instance 414 can be provided within the VIOSes as well, and the embodiments are described without specific limitation on whether the features are implemented on the management console 175 or on a VIOS 112 to which the management tool is communicatively connected. In one embodiment, LRUs 416a-n provide code/program instructions that are executed on one or more virtual processor resources of one or more VIOSes 112 within CEC 110 and/or on processor 702 of management console 175 to provide specific functions.

The flowcharts and block diagrams in the various figures presented and described herein illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the flow charts above, one or more of the methods are embodied in a computer readable medium containing computer readable code such that a series of steps are performed when the computer readable code is executed (by a processing unit) on a computing device. In some implementations, certain processes of the methods are combined, performed simultaneously or in a different order, or perhaps omitted, without deviating from the spirit and scope of the invention. Thus, while the method processes are described and illustrated in a particular sequence, use of a specific sequence of processes is not meant to imply any limitations on the invention. Changes may be made with regards to the sequence of processes without departing from the spirit or scope of the present invention. Use of a particular sequence is therefore, not to be taken in a limiting sense, and the scope of the present invention extends to the appended claims and equivalents thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, R.F, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. In a cluster-aware data processing system (DPS) having a Virtual Input/Output (I/O) Server (VIOS) cluster with a plurality of cluster aware VIOSes, a method comprising:
receiving a terminal debugging session request from a management console interface of a management console that is communicatively connected to at least a first VIOS of the VIOS cluster;
in response to receiving the terminal debugging session request, starting a debugger instance;
receiving a cluster selection via the management console interface, wherein the cluster selection identifies a selected VIOS cluster which has a plurality of client logical partitions (LPARs), each client LPAR having a system dump image stored within a distributed storage repository of the cluster-aware DPS;
the debugger instance receiving, from the management console interface, a selection of a first client LPAR and a second client LPAR from the plurality of client LPARs for analysis;
analyzing a first system dump image and a second system dump image, wherein the first system dump image is the system dump image associated with a first client LPAR, and wherein the second system dump image is the system dump associated with a second client LPAR; and
concurrently providing a first analysis of the first system dump image and a second analysis of the second system dump image to the management console interface, wherein multiple debug images of multiple client LPARs are supported within a single debugger instance.

2. The method of claim 1, the method further comprising:
in response to receiving the cluster selection, the debugger instance selecting a VIOS from the plurality of cluster aware VIOSes, wherein the selected VIOS includes a cluster management utility;
the debugger instance triggering the selected VIOS to perform the steps of:
identifying one or more client LPARs in the selected cluster;
identifying one or more system dump images assigned to the one or more client LPARs in the selected cluster; and
dynamically loading, to the debugger instance, the one or more system dump images assigned to the one or more client LPARs in the selected cluster;

3. The method of claim 2, wherein the first system dump image and the second system dump image contain a system state data, the system state data comprising at least one of:
a plurality of forensic information;
context information for one or more central processing units (CPUs) of a client LPAR; and
memory context information.

4. The method of claim 1, further comprising:
determining relational information between the first analysis and the second analysis via one or more logical reasoning utilities of the management console;
loading the relational information to the management console interface;
concurrently providing the relational information to the management console interface; and
enabling toggling between the first analysis, the second analysis, and the first relational information from the same management console interface within the same debugger instance.

5. The method of claim 4, the determining relational information further comprising determining one or more similarities between the system state data of the first system dump image and the second system dump image, wherein the relational information includes an analysis of the one or more similarities.

6. The method of claim 4, the determining relational information further comprising determining one or more differences of the system state data of the first system dump image and the second system dump image, wherein the relational information includes an analysis of the one or more similarities.

7. The method of claim 1, wherein the plurality of client LPARs comprise all client LPARs within the cluster-aware data processing system.

8. A data processing system comprising:
a processor;
an input/output (I/O) interface coupled to an external network, the external network comprising at least one computing electronic complex having a Virtual Input/Output (I/O) Server (VIOS) cluster with a plurality cluster aware VIOSes; and
a memory coupled to said processor, wherein said memory includes:
an operating system (OS) partition;
at least one virtual input/output (I/O) server (VIOS);
a management tool executing on the processor for enabling the data processing system to interface with at least one VIOS from the plurality cluster aware VIOSes; and
processing logic executing on the processor to perform the functions of:
receiving a terminal debugging session request from a management console interface of a management console that is communicatively connected to at least a first VIOS of the VIOS cluster;
in response to receiving the terminal debugging session request, starting a debugger instance;
receiving a cluster selection via the management console interface, wherein the cluster selection identifies a selected VIOS cluster which has a plurality of client logical partitions (LPARs), each client LPAR having a system dump image stored within a distributed storage repository of the cluster-aware DPS;
the debugger instance receiving, from the management console interface, a selection of a first client LPAR and a second client LPAR from the plurality of client LPARs for analysis;
analyzing a first system dump image and a second system dump image, wherein the first system dump image is the system dump image associated with a first client LPAR, and wherein the second system dump image is the system dump associated with a second client LPAR; and
concurrently providing a first analysis of the first system dump image and a second analysis of the second system dump image to the management console interface, wherein multiple debug images of multiple client LPARs are supported within a single debugger instance.

9. The data processing system of claim 8, the processing logic further performs the functions of:
in response to receiving the cluster selection, the debugger instance selecting a VIOS from the plurality cluster aware VIOSes, wherein the selected VIOS is communicatively connected to a cluster management utility;
the debugger instance triggering the selected VIOS to perform the steps of:
identifying the one or more client LPARs in the selected cluster,
identifying one or more system dump images assigned to the one or more client LPARs in the selected cluster, and
dynamically loading, to the debugger instance, the one or more system dump images assigned to the one or more client LPARs in the selected cluster;

10. The data processing system of claim 9, wherein the first system dump image and the second system dump image have therein a system state data, the system state data comprising at least one of:
a plurality of forensic information;
context information for one or more central processing units (CPUs) of a client LPAR; and
memory context information.

11. The data processing system of claim 8, the processing logic further comprising:
determining relational information between the first analysis and the second analysis via one or more logical reasoning utilities of the management console;
loading the relational information to the management console interface;
concurrently providing the relational information to the management console interface; and
enabling toggling between the first analysis, the second analysis, and the first relational information from the same management console interface within the same debugger instance.

12. The data processing system of claim 11, the processing logic for determining relational information further comprising logic the performs the function of determining one or more similarities between the system state data of the first system dump image and the second system dump image, wherein the relational information includes an analysis of the one or more similarities.

13. The data processing system of claim 11, the processing logic for determining relational information further comprising logic that performs the functions of determining one or more differences of the system state data of the first system dump image and the second system dump image, wherein the relational information includes an analysis of the one or more similarities.

14. The data processing system of claim 8, wherein the plurality of client LPARs comprise all client LPARs within the cluster-aware data processing system.

15. A computer program product comprising:
a computer readable storage medium; and
program code on said computer storage medium that when executed by a processor within a cluster-aware data processing system provides a plurality of functions comprising:
receiving a terminal debugging session request from a management console interface of a management console that is communicatively connected to at least a first VIOS of the VIOS cluster;
in response to receiving the terminal debugging session request, starting a debugger instance;
receiving a cluster selection via the management console interface, wherein the cluster selection identifies a selected VIOS cluster which has a plurality of client logical partitions (LPARs), each client LPAR having a system dump image stored within a distributed storage repository of the cluster-aware DPS;
the debugger instance receiving, from the management console interface, a selection of a first client LPAR and a second client LPAR from the plurality of client LPARs for analysis;
analyzing a first system dump image and a second system dump image, wherein the first system dump image is the system dump image associated with a first client LPAR, and wherein the second system dump image is the system dump associated with a second client LPAR; and
concurrently providing a first analysis of the first system dump image and a second analysis of the second system dump image to the management console interface, wherein multiple debug images of multiple client LPARs are supported within a single debugger instance.

16. The computer program product of claim 15, the program code further comprising code for:
in response to receiving the cluster selection, the debugger instance selecting a VIOS from the plurality cluster aware VIOSes, wherein the selected VIOS is communicatively connected to a cluster management utility;
the debugger instance triggering the selected VIOS to perform the steps of:
identifying the one or more client LPARs in the selected cluster,
identifying one or more system dump images assigned to the one or more client LPARs in the selected cluster, and
dynamically loading, to the debugger instance, the one or more system dump images assigned to the one or more client LPARs in the selected cluster;

17. The computer program product of claim 16, wherein the first system dump image and the second system dump image have therein a system state data, the system state data comprising at least one of:
a plurality of forensic information;
context information for one or more central processing units (CPUs) of a client LPAR; and
memory context information.

18. The computer program product of claim 15, the program code further comprising code for:
determining relational information between the first analysis and the second analysis via one or more logical reasoning utilities of the management console;
loading the relational information to the management console interface;
concurrently providing the relational information to the management console interface; and
enabling toggling between the first analysis, the second analysis, and the first relational information from the same management console interface within the same debugger instance.

19. The computer program product of claim 18, the program code for determining relational information further comprising code for determining one or more similarities between the system state data of the first system dump image and the second system dump image, wherein the relational information includes an analysis of the one or more similarities.

20. The computer program product of claim 18, the program code for determining relational information further comprising code for determining one or more differences of the system state data of the first system dump image and the second system dump image, wherein the relational information includes an analysis of the one or more similarities.
